(19) United States
(12) Patent Application Publication
(10) Pub. No.: US 2004/0048026 A1
(43) Pub. Date: Mar. 11, 2004

(54) Edge-sticking adhesive tape and method of manufacturing the tape

(76) Inventor: Shen-Nan Kan, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/236,924

(22) Filed: Sep. 9, 2002

(51) Int. Cl. B32B 9/00

(52) U.S. Cl. 428/42.2

(57) ABSTRACT

An edge-sticking adhesive tape and a method of manufacturing the tape, wherein the back side of the adhesive tape is added with a release layer, and a plurality of release papers or films are spaced and stuck on the front part of the adhesive layer; a plurality of portions of the adhesive layer and the release papers alternately arranged are cut to formed strips, so that each of the adhesive tape strips has one side thereof partially stuck with one of the release papers; thereby, the composed adhesive tape can likely be reeled into a roll without sticking by providing the release layer on the back side thereof, and thereby is convenient for shipping and storage. And the other side of the adhesive tape only has a one-face releasable release paper, thereby cost of material can be lowered; and when in use, the step of tearing can be reduced, the problem of creating waste can be solved.

### BACKGROUND OF THE INVENTION

1. Field of the Invention

The present invention is related to an edge-sticking adhesive tape and a method of manufacturing the tape, and especially to designing for edge-sticking of the adhesive tape and a method of manufacturing the tape, it can reduce the cost of production, provide the effects of saving resource and environment preservation, it particularly suits sealing of an important document such as an envelope, a paper bag, a plastic bag or the like.

2. Description of the Prior Art

By gradually getting complicated of works of people in pursuance of progressing of science and technology, mutual contact among people gets more important. In order to control time efficiency to send important documents, articles or samples to be manufactured to an opposite side, business of express delivery has been developed and has been the role of transmitting among people in the modem busy lives. However, when an important or confidential document or article is delivered from “A” location to “B” location by handing over, if there is no effective protective measure, a mail is hard to avoid from being disclosed, copied or changed over. An ordinary document can use an adhesive tape and glue to quickly seal the envelope thereof; the measure generally seen is an edge-sticking adhesive tape. The adhesive layer of the adhesive tape is stuck with a release paper with a severing line in the middle thereof, thereby it can be torn at one side and stuck on an envelope; while the other side can be torn and stuck when the envelope is sealed.

As shown in FIG. 1, an adhesive tape used presently was designed and developed according to this idea, wherein the inner layer of the adhesive tape 10 is stuck with a malpractice-preventing layer 513 with weaker adhesion and printed with series of signs, after the adhesive tape 10 is stuck onto the sealed area, if it has been torn off, part of the malpractice-preventing layer 513 will be stripped and attached to the envelope, and the signs for distinguishing can be disclosed to help detection of the above stated tearing off without a permission.

It is expected that, in continuing development of industrial and commercial economy, such malpractice-preventing adhesive tapes will gradually grow in pursuance of progressing of the business of express delivery, and will be more highly thought of and widely used.

Referring to FIG. 2, the conventional method of manufacturing an edge-sticking and malpractice-preventing adhesive tape is to stick a two-face releasable release paper 20 on the surface of a adhesive layer 11 of a adhesive tape 10, the adhesive tape 10 is convenient to be reeled for shipping and storage, and is convenient to be cut in strips and pulled out for use. And further for convenience of subsequent processing in the art of envelope manufacturing or use by users, the two-face releasable release paper 20 is provided with a severing line 30 suitably in the middle thereof, thereby the two-face releasable release paper 20 can be torn at one side and stuck on the flap 81 of an envelope 80; while the other side which has the remaining part of the two-face releasable release paper 20 for protecting the adhesive tape 10 is left unchanged and can be torn and stuck when the envelope 80 is sealed to thereby give an intact sealing state, hence an object of preventing tearing off without a permission can be effectively attained.

The structure of this edge-sticking and malpractice-preventing adhesive tape has the following defects when in use and manufacturing:

1. The entire adhesive tape 10 is different in thickness of material from that of the two-face releasable release paper 20, and this composed structure only allow part of the two-face releasable release paper 20 to be cut in the middle thereof, but the adhesive layer 11 shall not be touched and cut, control of cutting is very difficult; if the material is too thin or cutting is too deep, the adhesive tape 10 may be destructed by overly cutting or even is broken by cutting to become waste material which is unable to be used; while if the material is too thick or cutting is too shallow, the two-face releasable release paper 20 will be uneasy for separating by tearing, rather the two halves of the release paper 20 will be torn off as a whole, thus inconvenience of use is resulted.

2. The entire adhesive tape 10 can be reeled in a roll when in manufacturing, thereby structurally, it must use a two-face releasable release paper 20 with the same width as that of the adhesive layer 11, by virtue that the two-face releasable release paper 20 on one side shall be torn off for sticking onto the envelope 80 initially to become waste material and result wasting, if no manpower is used to remove it in the process of manufacturing, it must be taken out with an additional machine, this increases the cost of machine and results complication and inconvenience in processing.

### SUMMARY OF THE INVENTION

The primary object of the present invention is to provide an edge-sticking adhesive tape and a method of manufacturing the tape which is simple for manufacturing, can save material and can assure good manufacturing quality.

To get the above object, the present invention provides an edge-sticking adhesive tape and a method of manufacturing the tape, wherein the back side of the adhesive tape is added with a release layer, and a plurality of release papers or films are spaced and stuck on the front part of the adhesive layer; a plurality of portions of the adhesive layer and the release papers alternately arranged are cut to formed strips, so that each of the adhesive tape strips has one side thereof partially stuck with one of the release papers; thereby, the composed adhesive tape can likely be reeled in a roll without sticking by providing the release layer on the back side thereof, and thereby is convenient for shipping and storage. And the other side of the adhesive tape only has a one-face releasable release paper, thereby cost of material can be lowered, and when in use, the step of tearing can be reduced, the problem of waste creating can be solved.

The present invention will be apparent after reading the detailed description of the preferred embodiment thereof in reference to the accompanying drawings.

### BRIEF DESCRIPTION OF THE DRAWINGS

FIG. 1 is a perspective schematic view showing using of a conventional malpractice-preventing adhesive tape;

FIG. 2 is a perspective view showing the structure of a conventional malpractice-preventing adhesive tape;

FIG. 3 is a schematic view showing the step of cutting of an edge-sticking adhesive tape of the present invention;

FIG. 4 is a perspective view showing the appearance of the edge-sticking adhesive tape of the present invention;

FIG. 5 is a schematic view showing the step of manufacturing of a malpractice-preventing adhesive tape of the present invention with a doubled width;

FIG. 6a is a sectional view taken from an A-A′ sectional line in FIG. 5;

FIG. 6b is an enlarged sectional view of the adhesive layer of the present invention;

FIG. 7 is a flow chart showing the method of manufacturing of the present invention;

FIG. 8 is a schematic view showing use of the present invention with one side of the adhesive tape stuck on the flap of an envelope.

### DETAILED DESCRIPTION OF THE PREFERRED EMBODIMENT

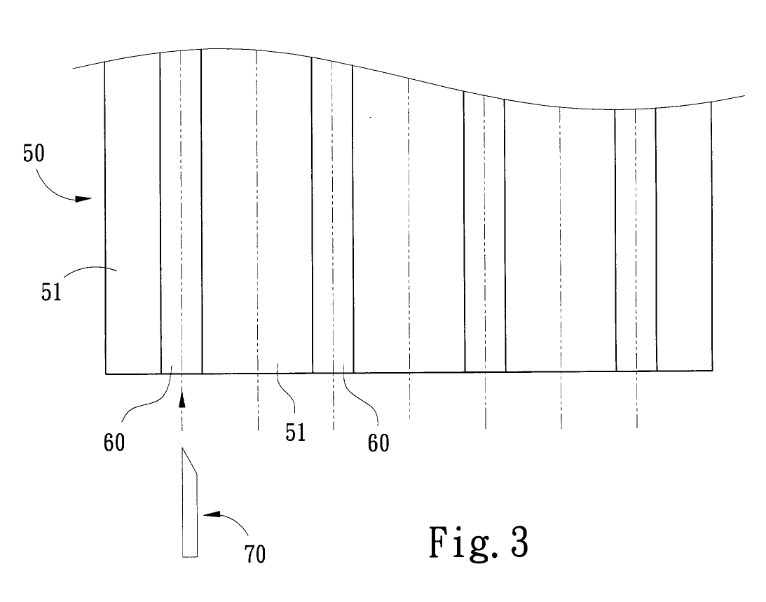

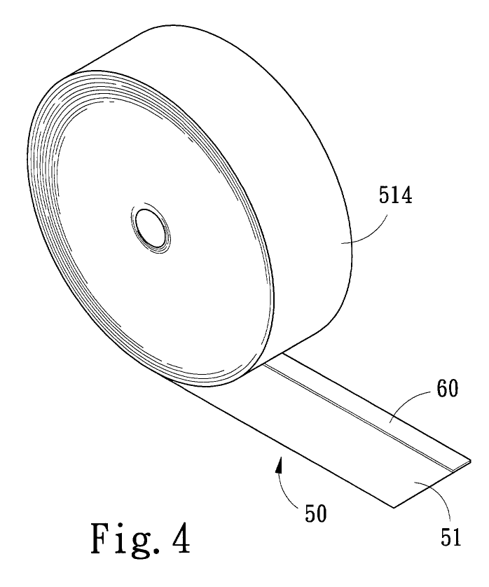

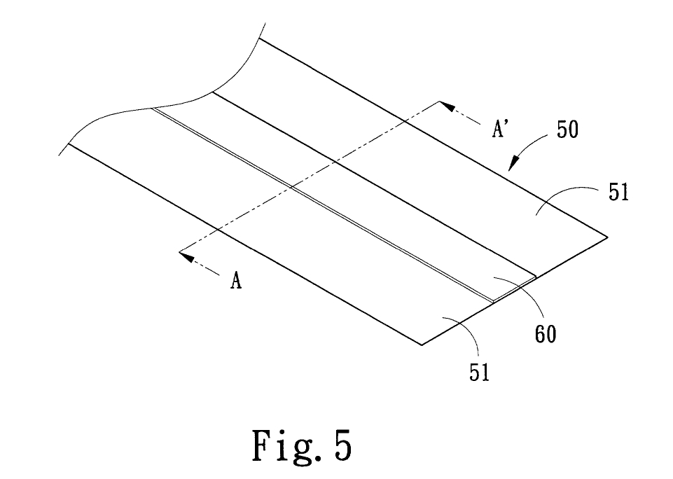

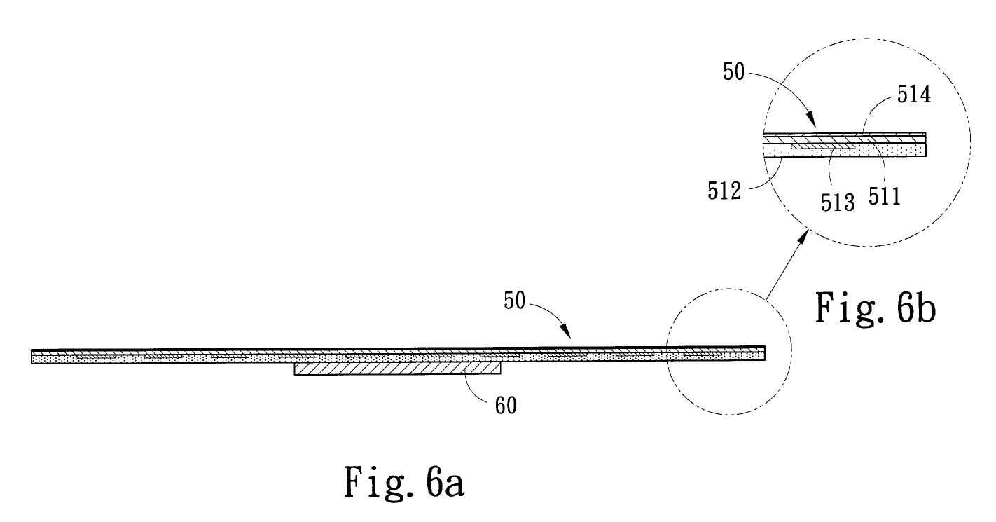

Referring firstly to FIGS. 3, 4, in the method of manufacturing the adhesive tape of the present invention, the back side of the adhesive tape 50 is added with a release layer 514, and a plurality of release papers or films 60 (of which each is one face or two faces releasable) are spaced and stuck on the front part of the adhesive layer 51; a plurality of portions of the adhesive layer 51 and the release papers 60 alternately arranged are cut by a cutting device 70 to form strips, so that each strip of the adhesive tape 50 has the side with the adhesive layers 51 thereof partially stuck with one of the release papers 60 which are narrower each.

Wherein, as shown in FIGS. 5 and 6a, the best mode of manufacturing is to provide an adhesive tape with a doubled width as compared with an adhesive tape product to be manufactured, every two portions of the adhesive layers 51 are provided therebetween and thereon with a one-face releasable release paper 60 with a narrower width as compared with the adhesive tape product to be manufactured, so that when the adhesive tape 50 is cut in the middle thereof, it forms two adhesive tape products.

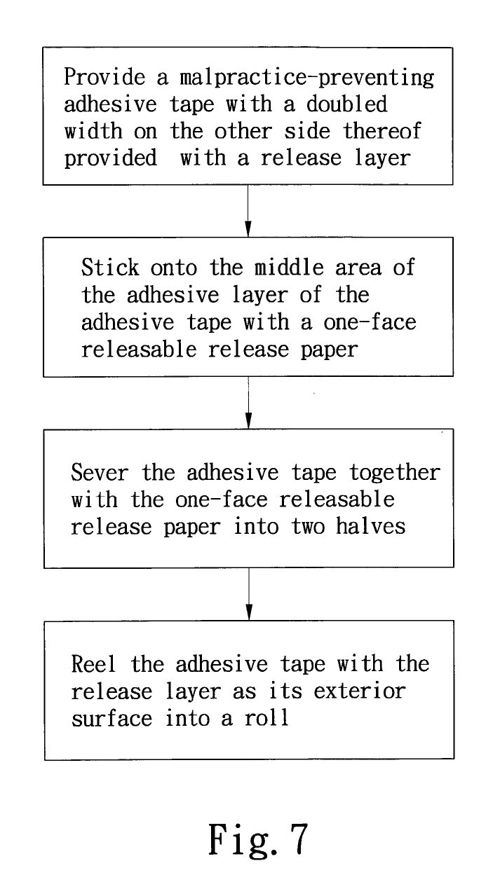

The above stated method can fast manufacture a generally used edge-sticking adhesive tape, referring to FIGS. 5 and 7 showing the method of integrally manufacturing the edge-sticking and malpractice-preventing adhesive tape with the steps as below:

1. Provide a malpractice-preventing adhesive tape 50 with a doubled width as compared with an adhesive tape product to be manufactured, and stuck on one side thereof with an adhesive layer 512 and a malpractice-preventing layer 513, and provided on the other side thereof with a release layer 514.

2. Make a one-face releasable release paper (or film) 60 and stick it onto the middle area of the adhesive layer 51 of the adhesive tape 50.

3. Sever the adhesive tape 50 together with the one-face releasable release paper 60 into two halves.

4. The adhesive tape 50 with the release layer 514 as its exterior surface is reeled into a roll.

Thereby, the composed adhesive tape 50 (referring to FIGS. 5 and 6) includes an adhesive layer 51 and a one-face releasable release paper 60, it is provided thereon with an adhesive layers 512 and a malpractice-preventing layer 513 and on the back side thereon with a release layer 514; with the release layer 514 on the back side thereof, the adhesive tape 50 can likely be reeled in a roll without sticking, and thereby is convenient for shipping and storage. And the other side of the adhesive tape 50 only has the one-face releasable release paper 60, thereby cost of material can be lowered; and when in use, the step of tearing can be reduced, the problem of creating waste can be solved.

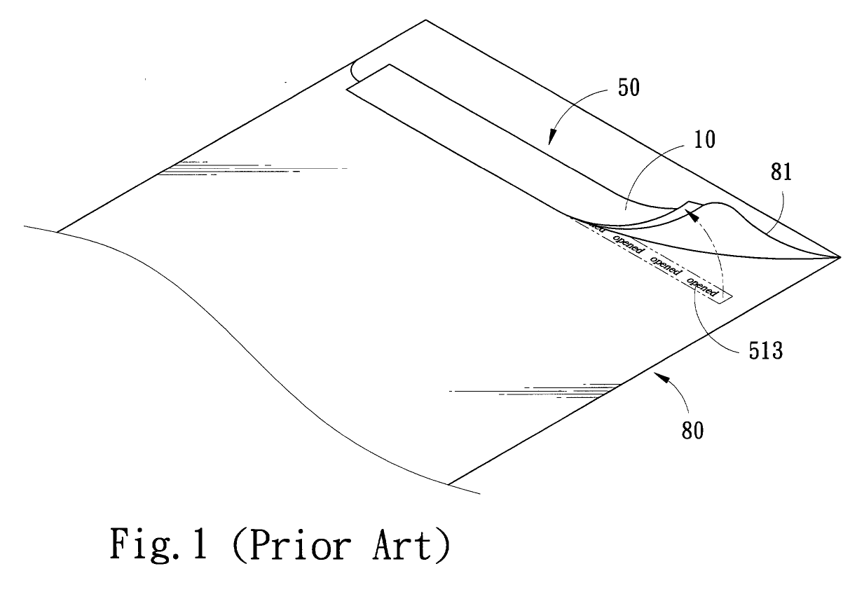

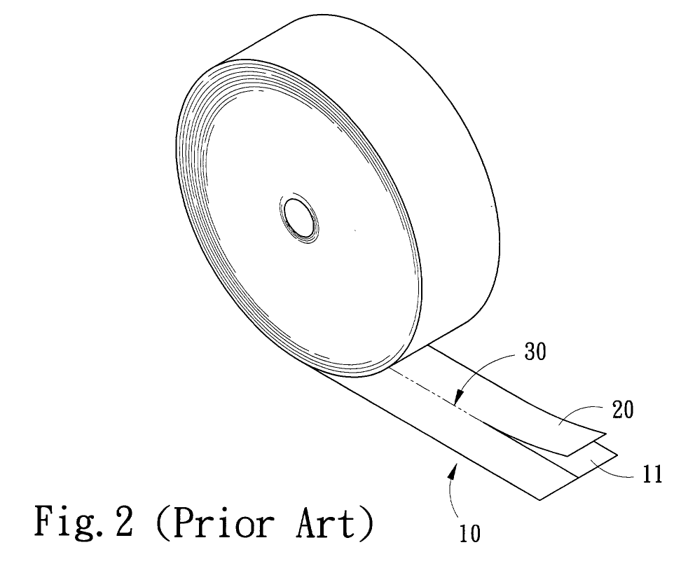

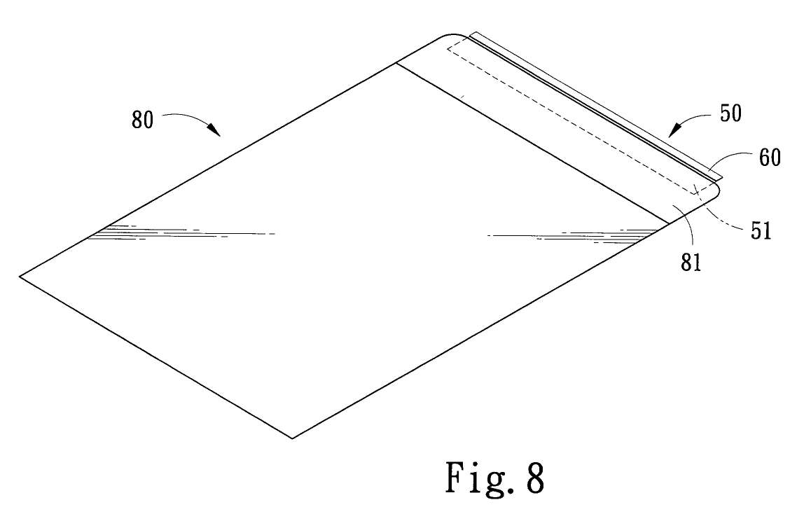

Referring to FIGS. 1, 4 and 8, when in use, it needs only to cut out an adhesive tape 50 in pursuance of the requirement, and to stick the exposed adhesive layer 51 onto a flap 81 of an article of an envelope or a paper bag 80 etc., the remaining part of the adhesive layer 51 stuck with the one-face releasable release paper 60 is unchanged. When the envelope 80 is sealed afterwards, the one-face releasable release paper 60 is torn off and the adhesive tape 50 with the remaining part of the adhesive layer 51 is stuck onto the envelope 80, the sealing function can thereby be provided; if the adhesive tape 50 is torn off the envelope 80, the malpractice-preventing layer 513 will be separated from the exterior surface of the adhesive tape 50 but distinguishing signs will appear on the envelope 80; even when the adhesive tape 50 is stuck back to the original sticking area, by the fact that the malpractice-preventing layer 513 is unable to be coincident with the original sticking area of the adhesive tape 50, this means that the envelope 80 has been uncovered, thereby, an object of detecting and preventing tearing off without a permission can be attained.

The method of manufacturing stated above can render the structural quality of the adhesive tape 50 more stable by virtue that the positions of severing are all on the strips of the adhesive tape 50; there is no such situation as those in a conventionally made adhesive tape which is cut but not completely cut or may be damaged when too deep cutting is done. And thereby the adhesive tape 50 can have consistent quality when it is reeled into a roll.

The present invention thereby has the following advantages:

1. By the method of manufacturing of the present invention, the malpractice-preventing adhesive tape can reduce the used amount of release papers to half of the conventional malpractice-preventing adhesive tape, it can reduce waste material and the step of tearing to provide the effects of increasing convenience for users, reducing cost of production and environment preservation.

2. By the method of manufacturing of the present invention, as to the equipment of production, in severing the malpractice-preventing adhesive tape into strips, tidy cutting with high quality can be obtained, no flaw in the product will be created by ununiform cutting induced by non-uniform applying of the adhesive layer and the malpractice-preventing layer to the inner layer of the adhesive tape. That is to say, the present invention needs only to use a cutting device to directly sever into strips; control of production can be more easily achieved.

In conclusion, the present invention can get its expected objects, and provides an edge-sticking and malpractice-preventing adhesive tape and a method of manufacturing the tape, it suits sealing and malpractice preventing of an envelope, a paper bag, a plastic bag, a package or the like with good function and is industrially practical.

Having thus described my invention, what I claim as new and desire to be secured by Letters Patent of the United States are:

1. An edge-sticking adhesive tape and a method of manufacturing said tape, wherein the back side of said adhesive tape is added with a release layer, and a plurality of release papers or films are spaced and stuck on the front part of said adhesive layer; a plurality of portions of said adhesive layer and said release papers alternately arranged are cut to form strips, so that each of said adhesive tape strips has one side thereof partially stuck with one of said release papers.

2. The edge-sticking adhesive tape and the method of manufacturing said tape as in claim 1, wherein said adhesive tape is provided to have a doubled width as compared with an adhesive tape product to be manufactured, said adhesive layer is provided in the middle thereof with a one-face releasable release paper with a narrower width as compared with said adhesive tape product to be manufactured, so that when said adhesive tape is cut in the middle thereof, it forms two adhesive tape products.

3. The edge-sticking adhesive tape and the method of manufacturing said tape as in claim 2, wherein the width of said one-face releasable release paper is smaller than that of any of said adhesive tape product to be manufactured after cutting.

4. An edge-sticking adhesive tape, wherein the back side of said adhesive tape is added with a release layer, the front part of said adhesive layer has one side thereof partially stuck with a one-face releasable release paper.

5. The edge-sticking adhesive tape as in claim 4, wherein said adhesive tape is a malpractice-preventing adhesive tape provided on one side thereof with an adhesive layer and a malpractice-preventing layer.
